(19) United States
(12) Patent Application Publication
(10) Pub. No.: US 2016/0003326 A1
(43) Pub. Date: Jan. 7, 2016

(54) TWO-SPEED TRANSMISSION FOR VEHICLE

(71) Applicant: Hyundai Motor Company, Seoul (KR)

(72) Inventors: Jong Yun PARK, Hwaseong-si (KR); Yeon Ho KIM, Suwon-si (KR); Kyung Ha KIM, Yongin-si (KR); Ki Nam Kim, Seongnam-si (KR); Wan Soo Kim, Hwaseong-si (KR); Jae Young CHOI, Busan (KR)

(73) Assignee: Hyundai Motor Company, Seoul (KR)

(21) Appl. No.: 14/548,154

(22) Filed: Nov. 19, 2014

(30) Foreign Application Priority Data
Jul. 4, 2014 (KR) 10-2014-0083495

(51) Int. Cl. F16H 3/00; F16H 3/12

(52) U.S. Cl. CPC F16H 3/006; F16H 3/126; F16H 2003/007; F16H 2200/0021; F16H 2200/0034

(57) ABSTRACT

A two-speed transmission for a vehicle may include a first input shaft, a second input shaft connected to a motor, and a clutch unit for selectively transmitting the power of the motor to an output shaft from the first input shaft and/or the second input shaft. The clutch unit may synchronize rotation speeds of the first input shaft and the second input shaft when the power of the motor is transmitted to the output shaft from the first input shaft.

### CROSS-REFERENCE TO RELATED APPLICATION

The present application claims priority of Korean Patent Application Number 10-2014-0083495 filed on Jul. 4, 2014, the entire contents of which application are incorporated herein for all purposes by this reference.

### BACKGROUND OF INVENTION

1. Field of Invention

The present invention relates to a two-speed transmission for a vehicle, and more particularly, to a two-speed transmission for a vehicle which is applicable to an electric vehicle or a hybrid vehicle.

2. Description of Related Art

A two-speed transmission for an electric vehicle of a related art embodies a high speed step and a low speed step by using a clutch and an external gear. FIG. 1a and FIG. 1b are views illustrating layouts of a two-speed transmission for an electric vehicle of a related art.

As illustrated in FIG. 1a and FIG. 1b, the two-speed transmission applied to an electric vehicle of a related art includes a friction clutch, an external gear, an one-way clutch, and a locking ring wherein the friction clutch and the one-way clutch are operated selectively to transmit power through different routes thereby to implement a low speed step and a high speed step of the two-speed transmission. Meanwhile, FIG. 2 is a view illustrating a layout of a two-speed transmission for an electric vehicle using a hollow input shaft.

As illustrated in FIG. 2, the two-speed transmission for an electric vehicle using a hollow input shaft includes a first and second hollow input shafts, a friction clutch, an external gear, and a shift mechanism wherein power is transmitted selectively from the first hollow input shaft and the second hollow input shaft according to an operation of the shift mechanism thereby to implement the two-speed transmission.

As described above, the two-speed transmission for an electric vehicle of a related art needs at least three external gears as well as the one-way clutch, the locking ring, the first and second hollow input shafts and the like in order to embody two shift steps. Thus, the increase in the number of components configuring the two-speed transmission for an electric vehicle of a related art leads to an increase of its manufacturing costs and of its weight accordingly.

Further, as the number of components configuring the two-speed transmission for an electric vehicle of a related art increases, the number of components that have to be controlled increases its acceleration ability, hill-climbing ability, and maximum speed ability of a vehicle are deteriorated, and it is disadvantageous to package the components configuring the two-speed transmission for a vehicle in a predetermined space.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention has been made in an effort to solve the above-described problems associated with the related art and/or other problems, and the present invention is not only to provide a two-speed transmission for a vehicle improving maximum speed ability, acceleration ability, and hill-climbing ability for a vehicle compared to the vehicle with a motor reducer of the related art but also to minimize the number of its components and accordingly its manufacturing costs and weight, when being applied to an electric vehicle.

In various aspects, the present invention provides a two-speed transmission for a vehicle, including: a first input shaft; a second input shaft connected to a motor; and a clutch unit for selectively transmitting the power of the motor to an output shaft from the first input shaft and/or the second input shaft, the clutch unit synchronizing rotation speeds of the first input shaft and the second input shaft when the power of the motor is transmitted to the output shaft from the first input shaft.

The clutch unit includes a first clutch for selectively transmitting the power of the motor to the first input shaft; and a second clutch installed in the second input shaft.

A first drive gear may be mounted on the first input shaft and a first clutch gear may be mounted on the first drive gear, a second drive gear may be mounted on the second input shaft and a second clutch gear may be mounted on the second drive gear, a first driven gear and a second driven gear may be mounted on the output shaft, and the first drive gear and the second drive gear may be engaged with the first driven gear and the second driven gear, respectively.

The second clutch may be connected to the second input shaft, and the second clutch may be positioned between the first clutch gear and the second clutch gear. The second clutch may be connected to the second clutch gear so that the power of the motor may be transmitted from the second input shaft to output shaft at a reference speed of driving or less.

The first clutch may be connected to the motor while the second clutch may be disconnected from the first clutch gear and the second clutch gear, thereby synchronizing the rotational speeds of the first input shaft and the second input shaft and transmitting the power of the motor to the output shaft from the first input shaft at a reference speed of driving or more. The first clutch may be disconnected from the motor and the second clutch may be connected to the first clutch gear while or after the rotational speeds of the first input shaft and the second input shaft are synchronized.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

The above and other features of the present invention will now be described in detail with reference to certain exemplary embodiments thereof illustrated by the accompanying drawings which are given herein below by way of illustration only, and thus are not limitative of the present invention, and wherein:

FIG. 1a and FIG. 1b are views illustrating layouts of a two-speed transmission for an electric vehicle of a related art;

FIG. 2 is a view illustrating a layout of another type of the two-speed transmission for an electric vehicle of a related art;

FIG. 3 is a view illustrating a layout of an exemplary two-speed transmission for a vehicle in accordance with the present invention;

FIG. 4a, FIG. 4b, and FIG. 4c are views illustrating operating conditions of an exemplary two-speed transmission for a vehicle in accordance with the present invention;

FIG. 5a is a graph comparing maximum speed of a vehicle equipped with an exemplary two-speed transmission of the present invention to maximum speed of the vehicle equipped with a motor reducer of the related art;

FIG. 5b is a graph comparing acceleration ability of a vehicle equipped with an exemplary two-speed transmission of the present invention to acceleration ability of the vehicle equipped with a motor reducer of the related art; and

FIG. 5c is a graph comparing hill-climbing ability of a vehicle equipped with an exemplary two-speed transmission of the present invention to hill-climbing ability of the vehicle equipped with a motor reducer of the related art.

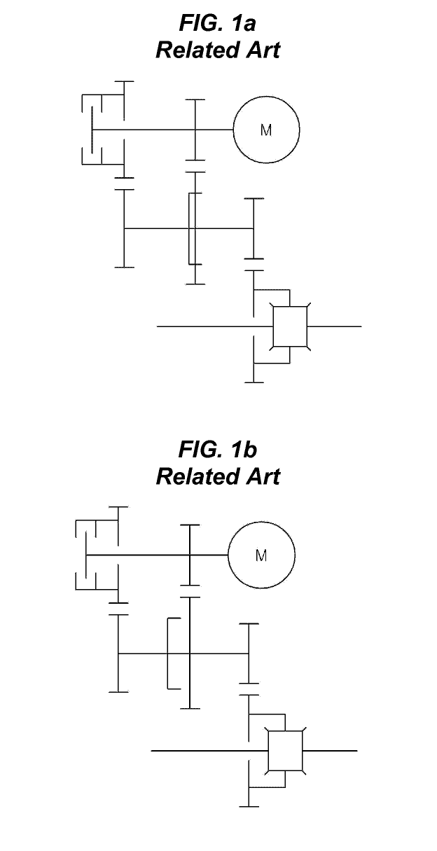

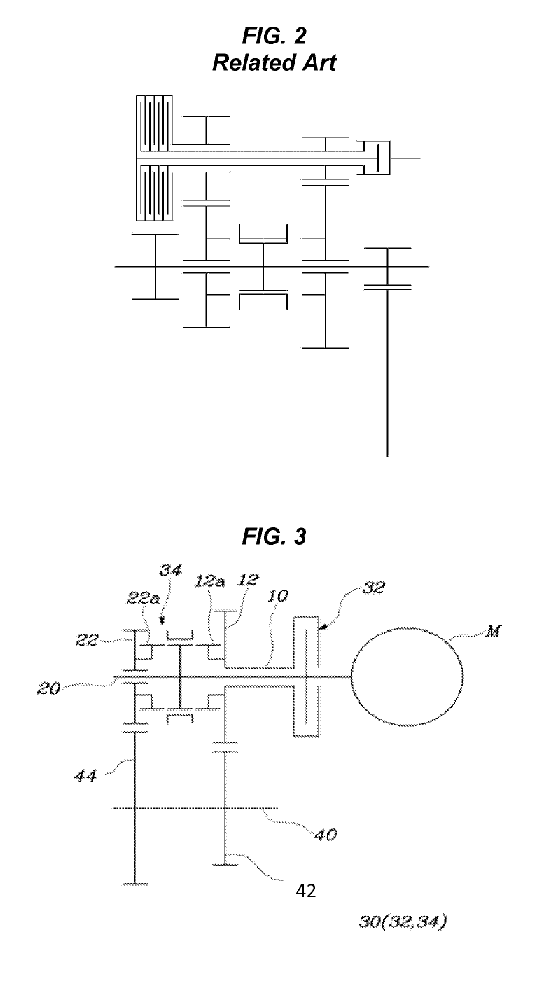

It should be understood that the appended drawings are not necessarily to scale, presenting a somewhat simplified representation of various preferred features illustrative of the basic principles of the invention.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Hereinafter, a two-speed transmission for a vehicle according to various embodiments of the present invention is described with reference to the accompanying drawings.

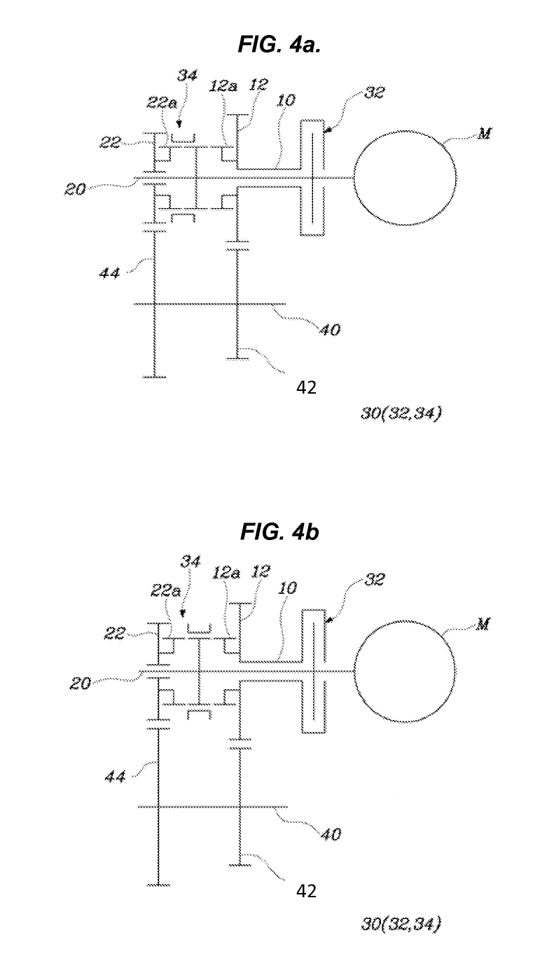

As shown in FIG. 3, the present invention relates to a two-speed transmission for a vehicle by which a motor reducer of the related art in an electric vehicle or a hybrid vehicle is replaced and in which two input shafts and a clutch unit are used to improve a motor efficiency, maximum speed ability, acceleration ability, hill-climbing ability and the like of a vehicle.

According to various embodiments of the present invention, there is provided a two-speed transmission for a vehicle, including: a motor M, a first input shaft 10, a second input shaft 20, and a clutch unit 30.

The first input shaft 10 and the second input shaft 20 are separated, which receive the power generated by the motor M. The first input shaft 10 is formed as a hollow shape and the second input shaft 20 has a structure directly connected to the motor M. The second input shaft 20 may be arranged to pass through the first input shaft 10 formed as a hollow shape.

The clutch unit 30 serves to transmit the power of the motor M to an output shaft 40 from the first input shaft 10 and/or the second input shaft 20. This clutch unit 30 connects the second input shaft 20 with a second drive gear 22 installed on the second input shaft 20 when it transmits the power of the motor M to the output shaft 40 through the second input shaft 20 having a structure directly connected with the motor M, and connects a first drive gear 12 installed on the first input shaft 10 to the second input shaft 20 after synchronization of rotation speeds of the first input shaft 10 and the second input shaft 20 when it transmits the power of the motor M to the output shaft 40 through the first input shaft 10 formed as a hollow shape.

The clutch unit 30 may include a first clutch 32 for selectively transmitting the power of motor M to the first input shaft 10, and a second clutch 34 installed on the second input shaft 20.

The first clutch 32 serves to selectively transmit the power to be transmitted from the motor M to the first input shaft 10.

The second clutch 34 is arranged between a first clutch gear 12a installed on the first drive gear 12 and a second clutch gear 22a installed on the second drive gear 22 wherein it may be connected to the first clutch gear 12a or to the second clutch gear 22a depending on the situation.

The first clutch 32 may use a dry clutch, while the second clutch 34 may use a dog clutch.

The second clutch 34 transmits the power via the first drive gear 12 and a first driven gear 42 to the output shaft 40 when being connected to the first clutch gear 12a, and outputs the power via the second drive gear 22 and a second driven gear 44 when being connected to the second clutch gear 22a.

As described above, the first drive gear 12 is mounted on the first input shaft 10 of the two-speed transmission for a vehicle according to various embodiments of the present invention, the first clutch gear 12a is mounted on the first drive gear 12, the second drive gear 22 is mounted on the second input shaft 20, and the second clutch gear 22a is mounted on the second drive gear 22.

The first driven gear 42 and the second driven gear 44 are installed on the output shaft 40 wherein the first driven gear 42 is engaged with the first drive gear 12 and the second driven gear 44 is engaged with the second drive gear 22.

In the two-speed transmission for an electric vehicle according to various embodiments of the present invention, the second clutch 34 is connected to the second clutch gear 22a such that the power of the motor M is transmitted to the output shaft 40 from the second input shaft 20 at a reference speed of driving or less, and the first clutch 32 is connected to motor M while disconnecting the second clutch 34 from the first clutch gear 12a and second clutch gear 22a, to synchronize rotational speeds of the first input shaft 10 and the second input shaft 20 and the first clutch 32 is disconnected from the motor M after connecting the second clutch 34 to the second clutch gear 22a such that the power of the motor M is transmitted to the output shaft 40 from the first input shaft 10 at a reference speed of driving or more, and then disconnecting the first clutch from the motor.

Hereinafter, specific operating procedure of the two-speed transmission for a vehicle according to various embodiments of the present invention will be described with reference to the accompanying drawings.

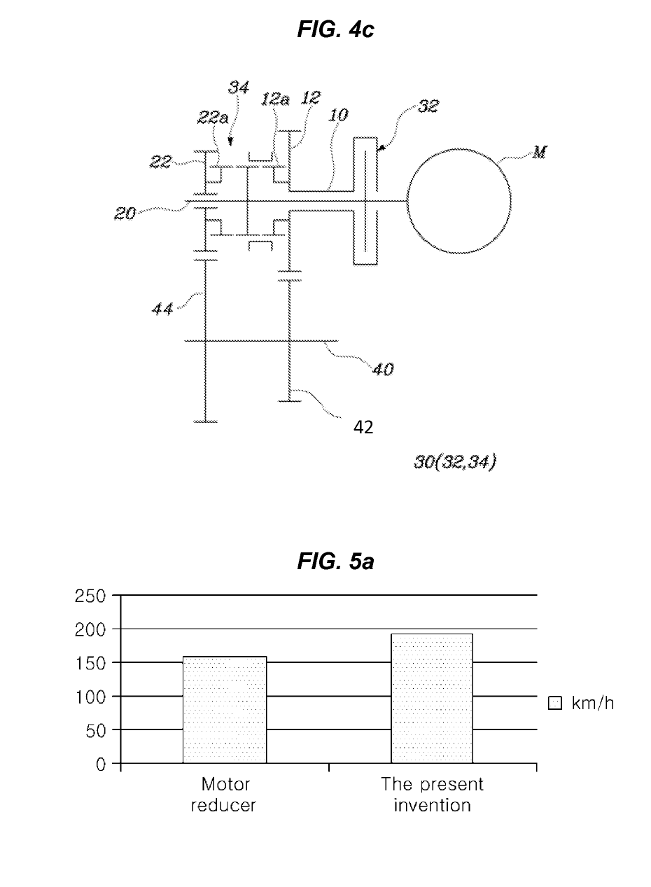

As shown in FIG. 4a, in the two-speed transmission for a vehicle according to various embodiments of the present invention, the second clutch 34 connects the second input shaft 20 and the second drive gear 22 at a low speed. That is, when the second clutch 34 is a dog clutch, a sleeve of the dog clutch connects the second clutch gear 22a installed on the second drive gear 22 and the second input shaft 20, and the power transmitted from the motor M is transmitted to the second driven gear 44 and ultimately to the output shaft 40. At this time, since the first clutch 32 is not connected with the motor M, the power is not transmitted to the first input shaft 10.

As shown in FIG. 4b, when it is shifted to a high speed from a low speed, firstly, the second clutch 34 is disconnected from the second drive gear 22. That is, when the second clutch 34 is a dog clutch, a sleeve of the dog clutch is disconnected from the second clutch gear 22a installed on the second drive gear 22. In this condition, the first clutch 32 is engaged, and thus the power of the motor M is transmitted to the first input shaft 10. As a result, rotation speeds of the first input shaft 10 and the second input shaft 20 are synchronized.

As shown in FIG. 4c, the sleeve of the dog clutch moves to be connected to the first clutch gear 12a and the first clutch 32 is disengaged while the rotational speeds of the first input shaft 10 and the second input shaft 20 are synchronized, thereby completing the shift.

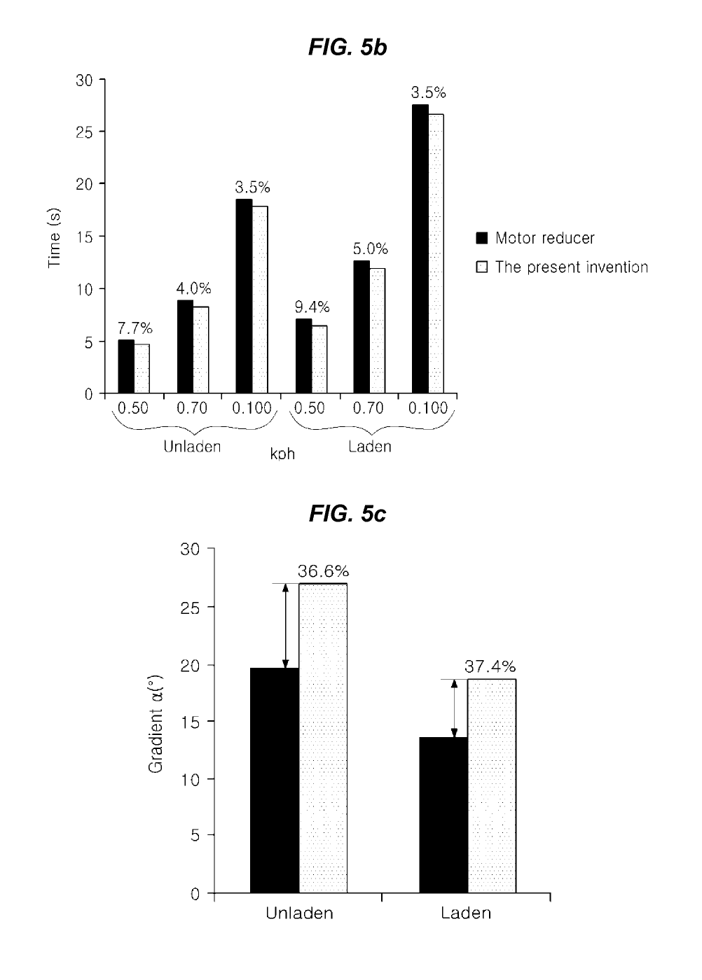

FIG. 5a is a graph comparing maximum speed of a vehicle equipped with an exemplary two-speed transmission of the present invention to maximum speed of the vehicle equipped with a motor reducer according to related art, FIG. 5b is a graph comparing acceleration ability of a vehicle equipped with an exemplary two-speed transmission of the present invention to acceleration ability of the vehicle equipped with a motor reducer according to related art, and FIG. 5c is a graph comparing hill-climbing ability of a vehicle equipped with an exemplary two-speed transmission of the present invention to hill-climbing ability of the vehicle equipped with a motor reducer according to the related art.

As shown in the FIG. 5a, FIG. 5b, and FIG. 5c, the maximum speed of a vehicle according to various embodiments of the present invention is improved up to 193 km/h, while the maximum speed of a vehicle when used the motor reducer of the related art was about 159 km/h, and acceleration ability and hill-climbing ability of vehicle are also improved both in the laden state and in the unladen state.

The present invention has various advantageous effects including the following. First, the efficiency of the motor is improved. Second, maximum speed ability, acceleration ability, and hill-climbing ability for an electric vehicle compared to the vehicle with a motor reducer are improved. Third, the number of components of the two-speed transmission for a vehicle is minimized. Forth, the number of its controlling elements is reduced, and its control is simple. Fifth, its manufacturing costs and weight are reduced. Sixth, since a clutch is not engaged during two-speed driving, hydraulic pressure or the power of a motor is not used, improving fuel efficiency.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A two-speed transmission for a vehicle, comprising:
a first input shaft;
a second input shaft connected to a motor; and
a clutch unit for selectively transmitting the power of the motor to an output shaft from the first input shaft and/or the second input shaft, the clutch unit synchronizing rotation speeds of the first input shaft and the second input shaft when the power of the motor is transmitted to the output shaft from the first input shaft.

2. The two-speed transmission for a vehicle of claim 1, wherein the clutch unit comprises:
a first clutch for selectively transmitting the power of the motor to the first input shaft; and
a second clutch installed on the second input shaft.

3. The two-speed transmission for a vehicle of claim 2, wherein:
a first drive gear is mounted on the first input shaft and a first clutch gear is mounted on the first drive gear,
a second drive gear is mounted on the second input shaft and a second clutch gear is mounted on the second drive gear,
a first driven gear and a second driven gear are mounted on the output shaft, and
the first drive gear and the second drive gear are engaged with the first driven gear and the second driven gear, respectively.

4. The two-speed transmission for a vehicle of claim 3, wherein the second clutch is connected to the second input shaft and the second clutch is positioned between the first clutch gear and the second clutch gear.

5. The two-speed transmission for a vehicle of claim 4, wherein the second clutch is connected to the second clutch gear so that the power of the motor is transmitted from the second input shaft to the output shaft at a reference speed of driving or less.

6. The two-speed transmission for a vehicle of claim 4, wherein the first clutch is connected to the motor while the second clutch is disconnected from the first clutch gear and the second clutch gear, thereby synchronizing the rotational speeds of the first input shaft and the second input shaft and transmitting the power of the motor to the output shaft from the first input shaft at a reference speed of driving or more.

7. The two-speed transmission for a vehicle of claim 6, wherein the first clutch is disconnected from the motor and the second clutch is connected to the first clutch gear while or after the rotational speeds of the first input shaft and the second input shaft are synchronized.
